(19) United States
(12) Patent Application Publication
(10) Pub. No.: US 2004/0233173 A1
(43) Pub. Date: Nov. 25, 2004

(54) Keypad for portable electronic devices

(76) Inventor: Bettina Bryant, Cary, NC (US)

Correspondence Address: COATS & BENNETT, PLLC, P O BOX 5, RALEIGH, NC, 27602, US

(21) Appl. No.: 10/441,722

(22) Filed: May 20, 2003

(51) Int. Cl. G09G 5/00

(52) U.S. Cl. 345/169

(57) ABSTRACT

An electronic device comprises a keypad having a plurality of keys, a first set of indicia associated with said keys for indicating key functions in a first operating mode, and a second set of indicia associated with said keys for indicating key functions in a second operating mode. The first set of indicia is oriented to be viewed in a first orientation and the second set of indicia is oriented to be viewed in a second orientation different from said first orientation.

### BACKGROUND OF THE INVENTION

The present invention relates generally to keypads for electronic devices and, more particularly, to a keypad that is adapted for use in multiple orientations.

Portable electronic devices, such as cellular phones, digital cameras, and audio players, have become increasingly popular. It is not uncommon for some people to have two or more such devices. The need to carry two or more devices to perform different functions is inconvenient for users. In response to consumer demands, manufacturers have begun to market and sell electronic devices that combine functions normally performed by two or more separate devices into a single unit. By way of example, a number of manufacturers currently offer camera phones, which are devices that combine a mobile radio communication device and digital camera within a single unit. This type of combined device provides greater consumer convenience. Further, because combined devices can use the same components for multiple functions, combined devices in general are less expensive than buying separate devices that perform the same functions.

One challenge in designing multi-function devices is providing convenient and readily-understandable controls for users. Electronic devices typically include a keypad that allows the user to input data into and control the operation of the device. The keypad typically comprises a plurality of keys arranged in a pattern with indicia located on or near the keys to identify the key function. In multi-function devices, keys in the keypad may have multiple functions, depending upon the operating mode of the device. The use of multi-function keys is necessary to minimize as much as possible the area consumed by the keypad.

In most electronic devices, the keypad is fixed and is designed to be viewed in a particular orientation. It may be desirable, however, to view and interact with the keypad in different orientations. For example, a camera phone may be designed to be used in either a vertical orientation or a horizontal orientation, depending upon the operating mode. In prior art devices, keypads are designed to be viewed from a single orientation. When the keypad is viewed in the “wrong” orientation, it becomes more difficult for the consumer to read the indicia associated with the keypad buttons and to select appropriate keys to enter data or to control the operation of the device.

### SUMMARY OF THE INVENTION

The present invention relates to an electronic device having a keypad that can be viewed and used in multiple orientations. In one embodiment of the invention, the keypad comprises a plurality of keys having indicia associated therewith to indicate the key functions. A first set of indicia is provided for viewing in a first orientation and a second set of indicia is provided for viewing in a second orientation. The indicia may be printed on or near the keys. In some embodiments, both sets of indicia will be visible at all times. In other embodiments, only one set of indicia may be visible at a time.

In another embodiment of the invention, a virtual keypad is displayed on a touch sensitive display. The keypad image displayed on the touch sensitive display may be changed depending upon the operational mode and/or orientation of the electronic device.

### BRIEF DESCRIPTION OF THE DRAWINGS

FIG. 1 is a block diagram of en electronic device according to a first embodiment of the present invention.

FIG. 2 is a perspective view of the first embodiment of the camera phone as seen from the front.

FIGS. 3 and 4 are perspective views of the first embodiment of the camera phone as seen from the back.

FIG. 5 is an exploded perspective view illustrating a keypad for the first embodiment of the camera phone.

FIG. 6 is an exploded perspective view of a keypad for a second embodiment of the camera phone of the present invention.

FIGS. 7 and 8 are perspective views of the second embodiment of the camera phone.

FIGS. 9 and 10 are perspective views of a third embodiment of the camera phone.

### DETAILED DESCRIPTION OF THE INVENTION

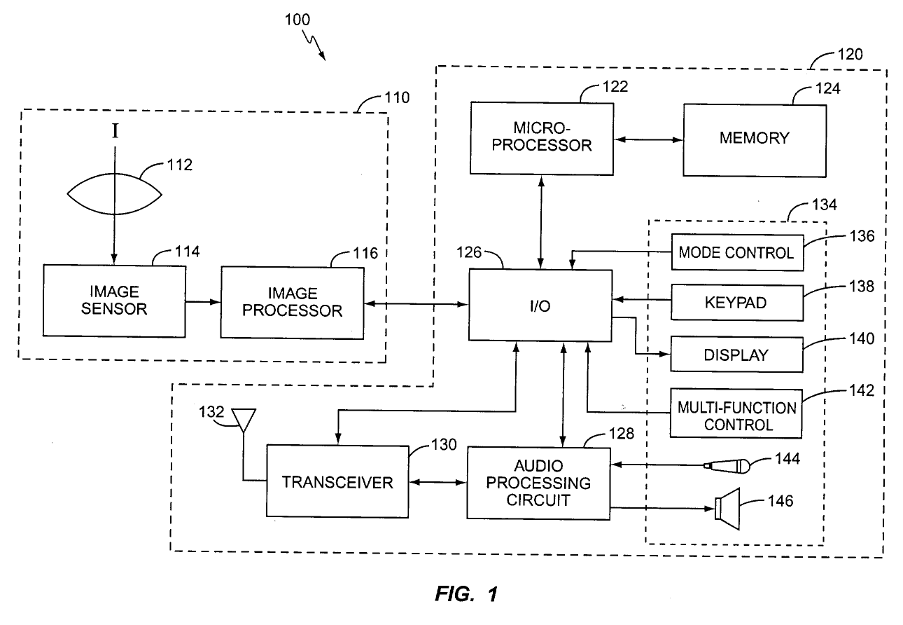

FIG. 1 is a block diagram of an exemplary multi-function electronic device according to the present invention. The exemplary embodiment combines a cellular telephone and camera into a single unit, and is referred to herein as camera phone 100. The present invention is not, however, limited to use in camera phones 100, but may be embodied in other electronic devices in which there is a need to view the keypad for two or more different orientations.

Camera phone 100 comprises a camera assembly 110 and communication circuit 120. Camera assembly 110 includes lens assembly 112, image sensor 114, and image processor 116. Lens assembly 112, which may comprise a single lens or a plurality of lenses, collects and focuses light onto image sensor 114. Image sensor 114 captures images formed by light collected and focused by lens assembly 112. Image sensor 114 may be any conventional image sensor 114, such as a charge-coupled device (CCD) or a complementary metal oxide semiconductor (CMOS) image sensor. Image processor 116 processes raw image data captured by image sensor 114 for subsequent storage in memory 124, output to a display 140, or for transmission by communication circuit 120. The image processor 116 may be a conventional signal processor programmed to process image data, which is well known in the art.

Communication circuit 120 comprises microprocessor 122, memory 124, input/output circuit 126, audio processing circuit 128, transceiver 130, antenna 132, and user interface 134. Microprocessor 122 controls the operation of camera phone 100 according to programs stored in memory 124. The control functions may be implemented in a single microprocessor, or in multiple microprocessors. Suitable microprocessors may include both general purpose and special purpose microprocessors. Memory 124 represents the entire hierarchy of memory needed to implement the functionality of the electronic device, and may include both random access memory (RAM) and read-only memory (ROM). Computer program instructions and data required for operation are stored in non-volatile memory, such a EPROM, EEPROM, or flash memory, which may be implemented as discrete devices or integrated with microprocessor 122.

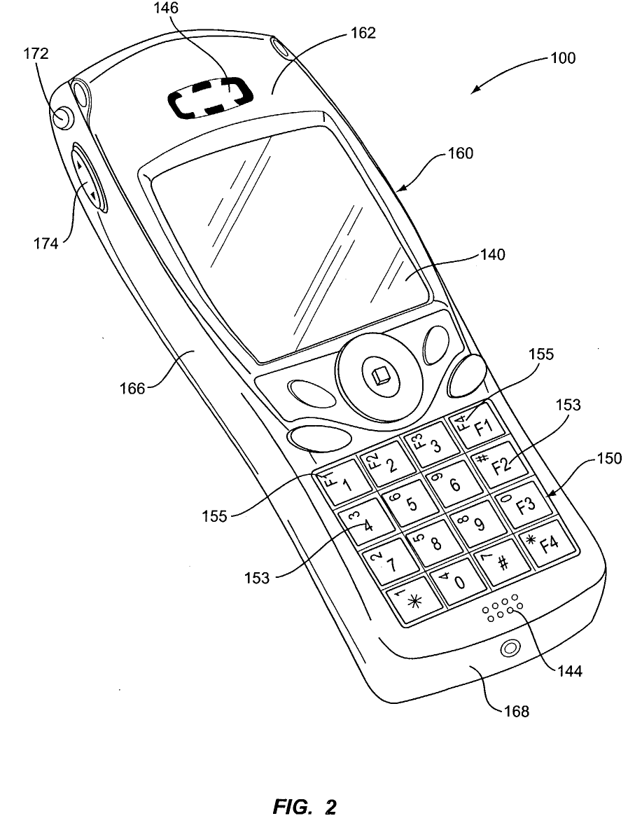

Input/output circuit 126 interfaces microprocessor 122 with image processor 116 of camera assembly 110, as well as with the transceiver 130, audio processing circuit 128, and user interface 134 of communication circuit 120. User interface 134 includes a keypad 150, display 140, microphone 144, and speaker 146. Keypad 150, disposed on a front face of camera phone 100 as seen in FIG. 2, includes a conventional alphanumeric keypad as is well known in the art. Keypad 150 allows the operator to enter information and commands to control operation of the camera phone 100. Camera phone 100 further includes a shutter control 172 and zoom control 174 disposed on one side 166 of the housing. The shutter control 172 and zoom control 174 function in a conventional manner. Display 140 allows the operator to view information while interacting with the camera phone 100. In the camera mode, the display 140 functions as a viewfinder. Microphone 144 converts the user's speech into electrical audio signals and speaker 146 converts audio signals into audible signals that can be heard by the user. Audio processing circuit 128 provides basic analog output signals to speaker 146 and accepts analog audio inputs from microphone 144. Transceiver 130 is coupled to antenna 132 for receiving and transmitting signals. Transceiver 130 is a fully functional cellular radio transceiver, which may operate according to any known standard, including the standards known generally as the Global System for Mobile Communications (GSM), TIA/EIA-136, cdma2000, UMTS, and Wideband CDMA.

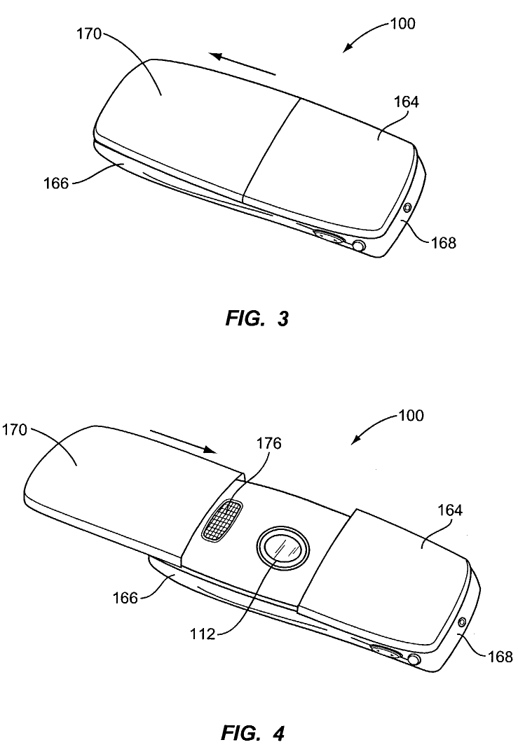

FIGS. 2-4 illustrates the physical appearance of the exemplary camera phone 100 according to the present invention. The camera phone 100 includes a housing 160 having a front cover 162, a back cover 164, right and left sides 166, and top and bottom ends 168. The keypad 150, display 140, microphone 144, and speaker 146 are disposed on the front cover 162 of the housing as seen best in FIG. 2. The back cover 164 of housing 160 may include a sliding panel 170 to conceal the lens assembly 112 and a flash 176. FIG. 3 shows the sliding panel 170 in a closed position, while FIG. 4 shows the sliding panel 170 in an open position.

The camera phone 100 of the present invention has multiple modes of operation, including a communication mode and a camera mode. In the communication mode, the camera phone 100 is used for communications. In the communication mode, the camera phone 100 transmits and receives voice and/or data. In the camera mode, the camera phone 100 is used for capturing and/or viewing images. The camera mode may, for example, comprise an image-capturing mode and an image-viewing mode. In the image-capturing mode, the camera phone 100 is used as a camera for taking pictures. In image-viewing mode, the camera phone 100 is used to view stored images.

The present invention contemplates that the camera phone 100 may be held in different orientations, depending upon the current operating mode of the camera phone 100. In a communication mode, the user holds the camera phone 100 in a generally vertical orientation. Thus, the keypad 150 is viewed in a vertical orientation. In contrast, the camera phone 100 is designed to be held in a generally horizontal orientation in the image-capturing mode. In the image-viewing mode, the camera phone 100 can be held in either a vertical or horizontal orientation. The orientation could be determined by the manufacturer of the camera phone 100, or could be selected by the user as one of a number of user preferences.

The camera phone 100 includes means for selecting the operating mode of the camera phone 100. The keypad 150 could, for example, have a mode select button for changing the operating mode of the camera phone 100. Alternatively, selection of the operating mode could be made via menu selection using the keypad 150 and display 140. In a preferred embodiment of the invention, a switch or sensor (not shown) detects the position of the sliding panel 170 and generates a mode control signal to change the default operating mode of the camera phone 100. The microprocessor 112 is responsive to the mode control signal to change the default operating mode. Thus, when the sliding panel 170 is in the closed position, the communication mode is selected by default. When the sliding panel 170 is in the open position the image-capturing mode is selected by default.

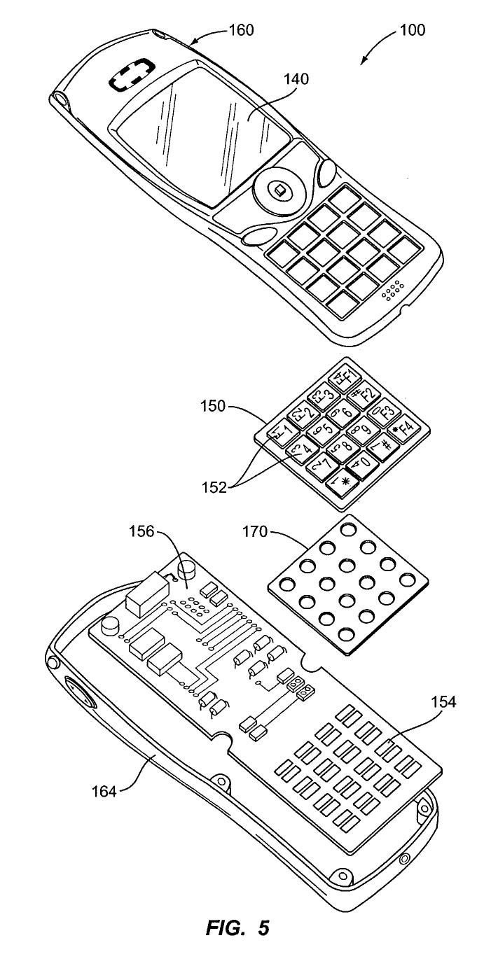

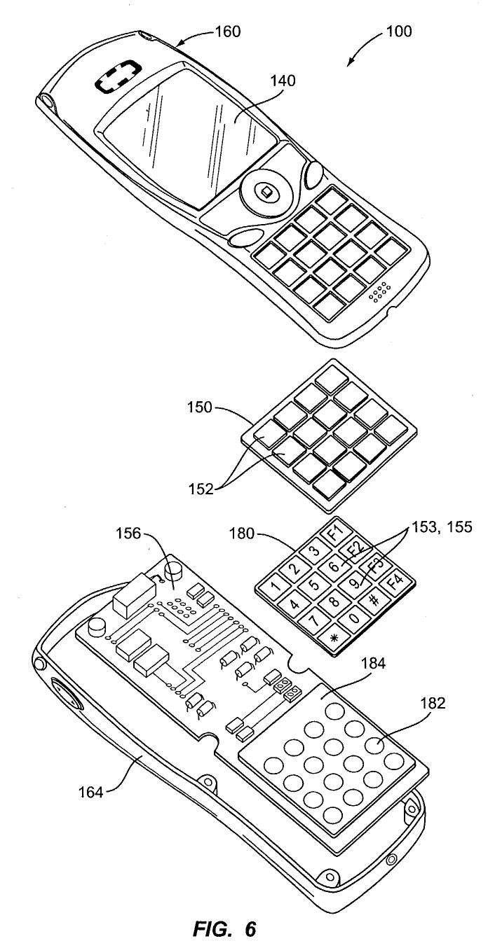

FIGS. 5 and 6 illustrate the keypad 150 for a first exemplary embodiment of the invention. As shown in FIG. 5 the keypad 150 includes a plurality of keys 152 that engage contact elements 154 on a printed circuit board 156 responsive to key operation. As seen in FIG. 2, the keys 152 have associated therewith a first set of indicia 153 that is viewed in a first orientation to indicate key functions, and a second set of indicia 155 that is viewed in a second orientation to indicate key functions. The first and second sets of indicia 153 and 155 may be printed on or near the keys 152. In the embodiment illustrated in FIG. 2, both sets of indicia 153, 155 are disposed on the surface of the keys 152 and rotated 90 degrees with respect to one another. The first and second indicia 153, 155 could, alternatively, be printed on the housing surface surrounding the keys 152.

The functions assigned to individual keys 152 may be the same in both the first and second orientations, or may be different. In the particular embodiment shown in FIGS. 2-5, the key functions are reassigned or remapped depending on the orientation or operating mode of the device. In this embodiment, the first set of indicia 153 corresponds to a first key mapping used when the camera phone is in a communication mode and the second set of indicia 155 corresponds to a second key mapping used when the camera phone is in an image-capturing mode. The microprocessor 122 includes logic to detect and interpret key presses depending on the selected operational mode. Alternatively, the logic for interpreting key presses could be implemented in a separate keypad controller.

FIG. 6 illustrates a keypad 150 for a second embodiment of the invention. In this embodiment, the first and second sets of indicia 153 and 155 are printed on a substrate or membrane 180 placed behind the keys 152 of the keypad 150. The keys 152 are transparent and overlay the first and second sets of indicia 153 and 155 on the substrate 180. Key switches 182, such as conventional dome switches, are incorporated into an insulated membrane 184 that overlies the printed circuit board 158. When a key 152 is pressed, a corresponding key switch 182 is actuated. The substrate or membrane 180 containing the first and second sets of indicia 153 and 155 should be sufficiently flexible to allow actuation of the key switches 182 when the keys 152 are pressed.

In the embodiment of FIG. 6, the substrate or membrane 180 carries the first and second sets of indicia 153 and 155, which are visible through the transparent keys 152. Thus, the indicia 153 and 155 should be printed at locations on the substrate or membrane 180 corresponding to the location of the keys 152. Any known printing techniques may be used to print the indicia 153 and 155 on the substrate or membrane 180.

In one embodiment of the invention, the substrate or membrane 180 may include or comprise a holographic film that operates on principles of optical diffraction to manipulate light. In this embodiment, the holographic film is exposed to a holographic laser recording process to define holographic images corresponding to the first and second sets of indicia 153 and 155. The first set of indicia 153 is visible when the camera phone 100 is viewed in a first orientation, and the second set of indicia 155 is visible when the camera phone 100 is viewed in a second orientation.

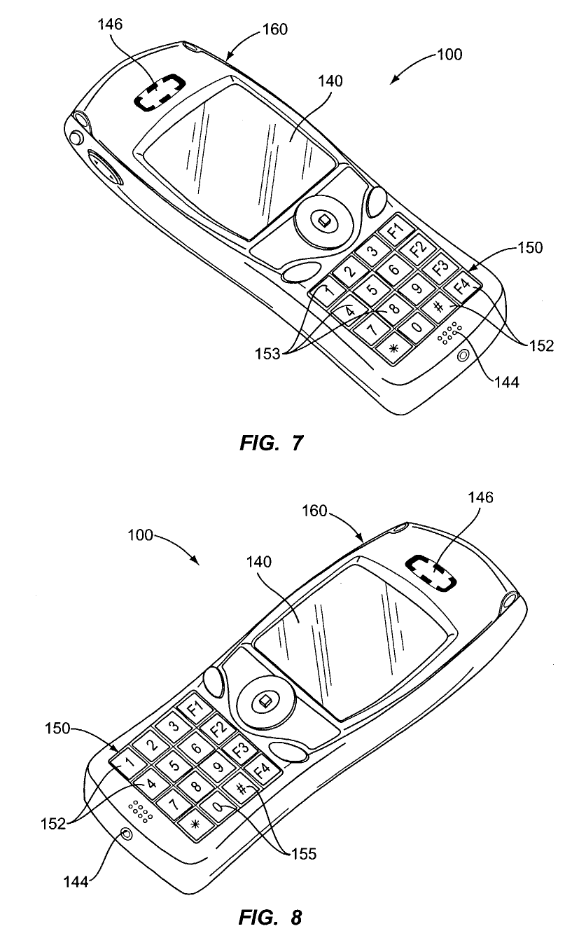

FIGS. 7 and 8 illustrate the second embodiment of the camera phone 100 that uses a holographic film. FIG. 7 illustrates the camera phone 100 when it is used in a communication mode and shows the first set of indicia 153. FIG. 8 illustrates the camera phone 100 when it is used in a camera mode and shows the second set of indicia 155. In this embodiment, only one set of indicia is visible at a time depending on the orientation of the camera phone 100.

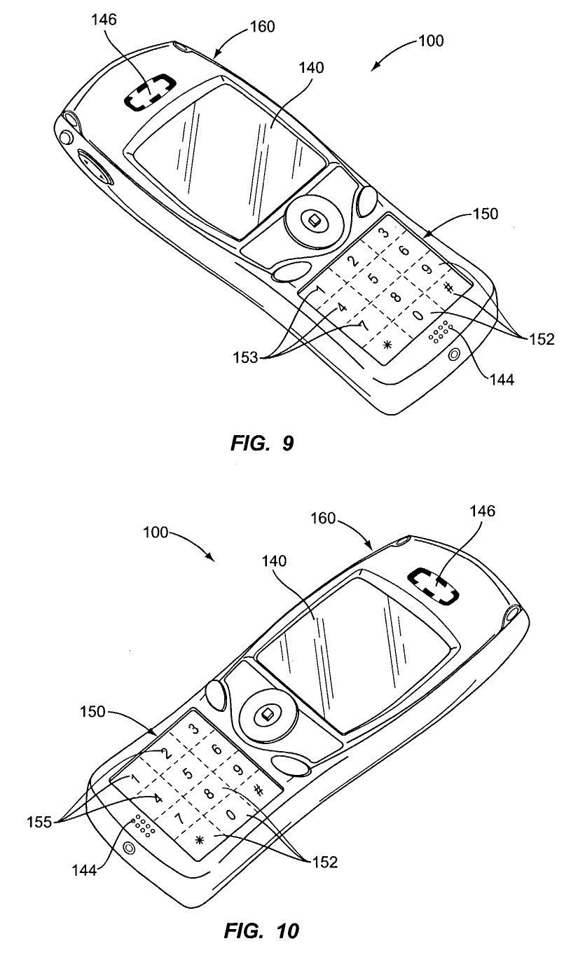

FIGS. 9 and 10 illustrate a third embodiment of the present invention. In the embodiment shown in FIGS. 9 and 10, the keypad 150 comprises a touch sensitive display that displays virtual keys 152. In this embodiment, a first keypad image is displayed in operating modes where the keypad 150 is likely to be viewed in a first orientation, and the a second keypad image is displayed when the camera phone 100 is in an operational mode where the keypad 150 is likely to be viewed in a second orientation. Keypad images for different operating modes may be stored in memory 124 and displayed under control of the microprocessor 122. For example, when the camera phone 100 is in a communication mode of operation, the microprocessor 122 may send to the touch sensitive display the first keypad image in which the keys 152 and associated indicia 153 are oriented for viewing in a first orientation. When the camera phone 100 is in a camera mode, the microprocessor 122 may send to the touch sensitive display a second keypad image in which the keys and corresponding indicia 155 are oriented for viewing in a second orientation. In this embodiment of the invention, there is no limit to the number of keypad images and/or orientations that can be displayed.

In a fourth embodiment, the touch sensitive display of the embodiment shown in FIGS. 9 and 10 can be replaced by a membrane switch. The surface of the membrane switch can have keys printed therein along with first and second sets of indicia rotated 90 degrees in a manner similar to the first embodiment. Alternatively, the surface of the membrane switch can be covered with a layer of holographic film that generates a holographic image of a keypad in a first orientation when the camera phone is held in a vertical orientation, and generates a holographic image of a keypad in a second orientation when the camera phone is held in a second orientation.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. An electronic device comprising:
a keypad having a plurality of keys;
a first set of indicia associated with said keys for indicating key functions, said first set of indicia oriented to be viewed in a first orientation;
a second set of indicia associated with said keys for indicating key functions, said second set of indicia oriented to be viewed in a second orientation different from said first orientation.

2. The electronic device of claim 1 wherein said electronic device has multiple operating modes, wherein said first set of indicia indicates key functions for a first operating mode, and wherein said second set of indicia indicates key functions for a second operating mode.

3. The electronic device of claim 2 wherein said electronic device further comprises a microprocessor to detect and respond to key presses.

4. The electronic device of claim 3 wherein said microprocessor uses a first key mapping to determine key functions in said first operating mode and a second key mapping to determine key functions in said second operating mode.

5. The electronic device of claim 2 wherein:
said electronic device comprises a camera phone;
said first set of indicia indicates key functions for a communication mode of operation; and
wherein said second set of indicia indicates key functions for a camera mode of operation.

6. The electronic device of claim 1 wherein said first and second sets of indicia are disposed on said keys of said keypad.

7. The electronic device of claim 1 wherein said first and second sets of indicia are holographic images visible when said electronic device is held in a particular orientation.

8. The electronic device of claim 7 wherein said first set of indicia is visible when said electronic device is held in a substantially vertical orientation, and wherein said second set of indicia is visible when said electronic device is held in a substantially vertical orientation.

9. The electronic device of claim 1 wherein said first and second sets of indicia are disposed on a substrate behind the keys of said keypad, and wherein said keys are transparent to allow viewing of said indicia on said substrate.

10. The electronic device of claim 9 wherein said substrate includes a holographic film and wherein said first and second sets of indicia are holographic images that are visible when said electronic device is held in a particular orientation.

11. The electronic device of claim 10 wherein said first set of indicia are visible when said electronic device is held in a substantially vertical orientation, and wherein said second set of indicia is visible when said electronic device is held in a substantially vertical orientation.

12. An electronic device comprising:
a touchscreen display;
a memory to store a first keypad image oriented for viewing in a first orientation and a second keypad image oriented for viewing in a second orientation; and
a microprocessor to output said first and second keypad images to said touchscreen display depending on an operating mode of said electronic device.

13. The electronic device of claim 12 wherein:
said electronic device comprises a camera phone having a communication mode of operation and a camera mode of operation;
said microprocessor outputs said first keypad image to said touchscreen display in said communication mode of operation; and
said microprocessor outputs said second keypad image to said touchscreen display in said camera mode of operation.

14. An electronic device comprising:
a keypad having a plurality of keys;
a microprocessor for detecting and interpreting key presses, wherein said microprocessor uses a first key mapping to determine key functions in a first operating mode and a second key mapping to determine key functions in a second operating mode.

15. The electronic device of claim 14 wherein:
said electronic device comprises a camera phone having a communication mode of operation and a camera mode of operation;
said microprocessor outputs uses said first key mapping in said communication mode of operation; and
said microprocessor outputs uses said second key mapping in said camera mode of operation.

16. The electronic device of claim 14 wherein said first key mapping corresponds to an operating mode in which the keypad is viewed in a vertical orientation, and wherein said second key mapping corresponds to an operating mode in which the keypad is viewed in a horizontal orientation.
